(19) United States
(12) Patent Application Publication
(10) Pub. No.: US 2026/0261913 A1
(43) Pub. Date: Sep. 3, 2026

(54) EDGE-BASED ROAMING CONTEXT MANAGEMENT

(71) Applicant: Cisco Technology, Inc., San Jose, CA (US)

(72) Inventors: Shree Narasimha Murthy, Milpitas, CA (US); Sanjay K. Hooda, Milpitas, CA (US); Sarath Gorthi Subrahmanya, Bangalore (IN); Prakash C. Jain, Milpitas, CA (US)

(21) Appl. No.: 19/066,434

(22) Filed: Feb. 28, 2025

(51) Int. Cl. H04W 28/08; H04W 8/02

(52) U.S. Cl. CPC H04W 28/0925; H04W 8/02

(57) ABSTRACT

Devices, systems, methods, and processes for facilitating edge-based roaming management are described herein. A roaming management logic, deployed at a network device maintains traffic steering policy information associated with a plurality of client devices. The network device detects a client device roaming from a first edge node in the network and identifies a subset of edge nodes to which the client device may roam to. The identification of the subset of edge nodes is based on a list of neighbor access points associated with an access point associated with the first edge node or a historical roaming pattern of the client device received by the network device. The network device transmits a traffic steering policy context or a group tag context associated with the client device to the identified subset of edge nodes based on the detection of the client device roaming from the first edge node.

The present disclosure relates to wireless communication. More particularly, the present disclosure relates to edge-based roaming context management.

### BACKGROUND

With the rise of digitization and the adoption of work-from-anywhere models, enterprise networks have experienced a significant surge in Internet of Things (IoT) devices and bring your own device (BYOD) adoption. While these advancements enhance flexibility and productivity, they also increase the threat surface and introduce more complex attacks. Traditional perimeter-based security models may face limitations in effectively addressing these evolving challenges. To mitigate these risks, network architectures have transitioned to zero-trust security models, which emphasize granular control over both north-south and east-west traffic, minimizing the risk of lateral movement in cyberattacks.

In this context, policy-driven traffic steering can support the enforcement of security measures and direct traffic through various inspection nodes. Existing policy-driven traffic steering architectures offer a policy-driven approach to traffic steering, addressing some of the security challenges by redirecting traffic to security services such as firewalls. Ingress edge nodes manage traffic redirection based on service steering policies fetched from a policy server (such as an identity service engine). For wired endpoints, which are relatively static, this mechanism works well, as the service policies and destination group tags are resolved during onboarding. However, as enterprises increasingly adopt wireless-first models, the existing solutions may face limitations in supporting client roaming. Wireless clients frequently roam between access points connected to different edge nodes. This mobility can pose challenges to maintaining seamless client context between edge nodes, which can lead to potential traffic disruptions or packet drops.

### SUMMARY OF THE DISCLOSURE

Systems and methods for facilitating edge-based roaming context management in accordance with embodiments of the disclosure are described herein. In many embodiments, a network device comprises a processor, a network interface controller, and a memory. The network interface controller is configured to provide access to a network comprising a plurality of edge nodes. The memory is coupled to the processor and comprises a roaming management logic. The roaming management logic is configured to detect a client device roaming from a first edge node among the plurality of edge nodes, and transmit at least one of a traffic steering policy context or a group tag context associated with the client device to a subset of edge nodes among the plurality of edge nodes based on the detection of the client device roaming from the first edge node. The subset of edge nodes comprises at least a second edge node to which the client device is roaming from the first edge node.

In a number of embodiments, the group tag context comprises one or more Destination Internet Protocol to Destination Group Tag mappings associated with the client device.

In a variety of embodiments, the group tag context comprises one or more Destination Internet Protocol to Destination Group Tag mappings associated with the client device that are different between the first edge node and at least one edge node in the subset of edge nodes.

In further embodiments, the traffic steering policy context comprises one or more configurations to steer network traffic of the client device.

In still further embodiments, the transmission of the at least one of the traffic steering policy context or the group tag context to the second edge node is prior to an arrival of network traffic associated with the client device at the second edge node.

In more embodiments, the transmission of the at least one of the traffic steering policy context or the group tag context to the subset of edge nodes is independent of solicitation from the subset of edge nodes.

In still more embodiments, the transmission of the at least one of the traffic steering policy context or the group tag context to the subset of edge nodes is without solicitation from the subset of edge nodes.

In additional embodiments, prior to roaming, the client device is communicatively coupled to an access point (AP) associated with the first edge node. The roaming management logic is further configured to receive a list of one or more neighbor access points associated with the access point, and identify, from among the plurality of edge nodes, the subset of edge nodes associated with the one or more neighbor access points in the received list. The transmission of the at least one of the traffic steering policy context or the group tag context associated with the client device is further based on the identification of the subset of edge nodes.

In still additional embodiments, the roaming management logic is further configured to receive a historical roaming pattern of the client device, predict a roaming pattern of the client device based on the historical roaming pattern, and identify, from among the plurality of edge nodes, the subset of edge nodes based on the roaming pattern of the client device. The transmission of the at least one of the traffic steering policy context or the group tag context associated with the client device is further based on the identification of the subset of edge nodes.

In numerous embodiments, the network device corresponds to a service control plane node in the network.

In several additional embodiments, the roaming management logic is further configured to maintain traffic steering policy information associated with a plurality of client devices including the client device, and wherein the traffic steering policy information comprises the traffic steering policy context of the client device.

In yet several embodiments, the roaming management logic is further configured to receive one or more requests from the first edge node; and maintain a plurality of Destination Internet Protocol to Destination Group Tag mappings associated with the one or more requests. The group tag context associated with the client device comprises one or more Destination Internet Protocol to Destination Group Tag mappings of the plurality of Destination Internet Protocol to Destination Group Tag mappings.

In several embodiments, the roaming management logic is further configured to transmit the at least one of the traffic steering policy context or the group tag context as a part of client-context associated with the client device.

In numerous additional embodiments, the roaming management logic is further configured to transmit the at least one of the traffic steering policy context or the group tag context using a vendor-specific Locator/ID Separation Protocol (LISP) Location-Class Attribute Format (LCAF) message format.

In further more embodiments, the subset of edge nodes comprises one or more network access devices (NAD) in the network.

In yet more embodiments, an edge node device comprises a processor, a network interface controller configured to provide access to a network, and a memory. The memory is communicatively coupled to the processor and the memory comprises a roaming management logic configured to receive, prior to an arrival of network traffic associated with a client device and without solicitation, at least one of a traffic steering policy context or a group tag context associated with the client device, receive the network traffic from the client device; and steer the received network traffic based on the received at least one of the traffic steering policy context or the group tag context.

In still yet more embodiments, the client device has roamed to the edge node device from another edge node device in the network.

In many further embodiments, the roaming management logic is further configured to install the received at least one of the traffic steering policy context or the group tag context in an information database.

In still yet further embodiments, the roaming management logic is further configured to delete the received at least one of the traffic steering policy context or the group tag context from the information database based on the received at least one of the traffic steering policy context or the group tag context being unused for a configured time-period.

In numerous additional embodiments, a method comprises detecting a client device roaming from a first edge node among a plurality of edge nodes; and transmitting at least one of a traffic steering policy context or a group tag context associated with the client device to a subset of edge nodes among the plurality of edge nodes based on the detection of the client device roaming from the first edge node. The subset of edge nodes comprises at least a second edge node to which the client device is roaming from the first edge node.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is an illustrative representation of a network infrastructure arrangement in a network of a network overlay fabric in accordance with various embodiments of the disclosure;

FIG. 2 is a conceptual block diagram of a network fabric highlighting policy-driven traffic steering in accordance with various embodiments of the disclosure;

FIG. 3 is a conceptual diagram that illustrates a network fabric utilized in network traffic policy steering and service mapping in accordance with various embodiments of the disclosure;

FIG. 4 is a conceptual diagram that illustrated a network fabric utilized in edge-based roaming context management per network site in accordance with various embodiments of the disclosure;

FIG. 5 is a flowchart depicting a process for edge-based roaming context management in accordance with various embodiments of the disclosure;

FIG. 6 is a flowchart depicting a process for transmission of traffic steering policy context or group tag context in accordance with various embodiments of the disclosure;

FIG. 7 is a flowchart depicting a process for roaming pattern based roaming context management in accordance with various embodiments of the disclosure;

FIG. 8 is a flowchart depicting a process for edge-based roaming context management in accordance with various embodiments of the disclosure; and

FIG. 9 is a conceptual block diagram of a device suitable for configuration with a roaming management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate edge-based roaming context management. With the increasing dependency on digital transformation and remote work models, enterprise networks are witnessing a rapid influx of Internet of Things (IoT) and bring your own device (BYOD) endpoints. While these advancements improve operational flexibility and efficiency, they also significantly expand the attack surface and introduce more sophisticated security threats. Existing network architectures utilize a policy-driven traffic steering approach to steer dynamic traffic influx to various security services such as firewalls. In the policy-driven traffic steering approach, ingress edge nodes enforce traffic steering policies retrieved from a centralized policy server. This mechanism is effective for wired endpoints, as wired endpoints remain relatively static, allowing service policies and group tags (such as source group tags, destination group tags, or the like) to be established during device onboarding.

However, as enterprises increasingly embrace wireless-first network strategies, existing network architectures face challenges in ensuring seamless client mobility. Unlike wired devices, wireless clients frequently roam between access points, which are connected across different edge nodes. This movement may introduce challenges for policy-driven traffic steering, as traffic steering policy context and group tag context of a roaming client is transferred to a “roamed-to” edge node a posteriori, after the “roamed-to” edge node receives traffic from the roaming client. While on-demand transfer of the traffic steering policy context and the group tag context is suitable when the client is onboarded for the first time, as traffic flow has not yet started, in the context of roaming, this approach can be challenging. Since traffic flow of the roaming client is already in progress, transferring the traffic steering policy context and the group tag context after the traffic flow reaches the “roamed-to” edge node may lead to delays, potentially causing temporary traffic interruptions or packet loss.

Therefore, to maintain security enforcement and uninterrupted service steering in wireless environments, the present disclosure provides a solution that may ensure that minimizes traffic loss or packet drop at a “roamed to” edge node when a client device roams. In other words, the present disclosure provides a network device in a wireless network that performs edge-based roaming context management, ensuring that a traffic steering policy context, a group tag context of a roaming client device, or both are available at the “roamed to” edge node prior to traffic of the roaming client device reaching the “roamed to” edge node. The network device may be an edge-based network device (e.g., a service control plane node, a policy server, Software-Defined Networking “SDN” Controllers, Identity Services Engine “ISE”, Service Function Chaining “SFC” Controllers, Network Orchestrators in Cloud, Software-Defined Wide Area Network “SD-WAN”, or the like). The network device can also correspond to a cloud-based server. The network device may include a roaming management logic that may be configured to manage edge-based roaming context of one or more client devices in the wireless network.

The wireless network may further include edge nodes communicatively coupled to the network device, access points (APs) coupled to the edge nodes, and the client device(s) coupled to the APs. In many embodiments, the client device(s) can roam between the APs distributed across the wireless network, dynamically updating connections based on signal strength and mobility patterns. As user(s) move, their client device(s) assess available APs and transition to those APs that offer better connectivity and performance. The edge nodes may correspond to Network Access Devices (NADs). “NAD” (also referred to as an “access node”) may refer to a network component configured to manage and control client access (e.g., enforce access policies) within the wireless network. Further, NADs can include switches, routers, or wireless controllers communicatively coupled to the APs to enforce traffic steering and policy-based routing, directing traffic as per traffic steering policy context and group tag context associated with corresponding client devices. Each edge node may be communicatively associated with the network device for managing traffic flow, enforcing security policies, and steering traffic to designated security services.

In several embodiments, the network device may be configured to maintain traffic steering policy information associated with a plurality of client devices (e.g., smartphones, tablets, laptops, smartwatches, smart home sensors, smart appliances, or the like) in the wireless network. The traffic steering policy information may include traffic steering policy context of the client devices. For example, the traffic steering policy of the client devices may define how network traffic is managed and directed within the wireless network. The traffic steering policy context may include one or more configurations to steer network traffic of the client devices. The configuration(s) can include one or more traffic prioritization rules that determine which types of traffic, such as voice, video, or data, shall be given higher priority. The configuration(s) can further include one or more Quality of Service (QoS) parameters, specifying latency, jitter, and bandwidth allocation, one or more load balancing strategies, a path selection criteria, one or more security policies, or the like.

In yet various embodiments, the network device may be configured to receive different types of requests from the edge nodes such as access requests, traffic routing requests, policy enforcement requests, or the like. The network device may be further configured to maintain a plurality of Internet Protocol to group tag mappings associated with these requests. For example, the plurality of Internet Protocol to group tag mappings may include Destination Internet Protocol (DIP) to destination group tag (DGT) mappings, Source Internet Protocol (SIP) to source group tag (SGT) mappings, or the like. In an example, the DIP to DGT mappings, SIP to SGT mappings, or the like may correspond to group tag context maintained at the network device. DIP to DGT mapping may be utilized to associate an IP address with a predefined security or policy-based group tag. DIP to DGT mapping may allow an edge node to classify, enforce policies, and control traffic based on group-based access. For example, if a specific DIP belongs to a sensitive database, the DIP may be mapped to a high-security DGT, ensuring that only authorized source groups can communicate with the sensitive database. Further, SIP to SGT mapping may enable identification of which security group a source device belongs to, enabling policy-based access control.

In yet various embodiments, a client device among the plurality of client devices in the wireless network may be currently coupled to a first AP associated with a first edge node in the wireless network. In an example, the first node may correspond to an ingress edge node for the client device. “Ingress edge node” may refer to a network entry point where network traffic first arrives, is processed, and is steered/directed based on traffic steering policies before being forwarded to corresponding destination. Further, the client device may be about to roam from the first AP to a second AP (e.g., a new AP). In an example, the second AP may be among one or more neighboring APs of the first AP. Further, the second AP may be associated with a second edge node, in the wireless network, that is different from the first edge node. In such embodiments, the network device may be configured to detect the client device roaming from the first edge node. In a number of embodiments, based on the detection of the roaming client device, the network device may be configured to determine at least one of a traffic steering policy context or a group tag context associated with the roaming client device.

In a variety of embodiments, the network device may be further configured to identify a subset of edge nodes in the wireless network based on the detection of the client device roaming from the first edge node. In more embodiments, the subset of edge nodes may only include the second edge node to which the client device is roaming to from the first edge node. In yet more embodiments, the subset of edge nodes may include all those edge nodes that are coupled to one or more neighbor APs of the first AP to which the client device is currently associated. In such embodiments, the identification of the subset of edge nodes may be based on a list of one or more neighbor APs associated with the first AP. In other words, prior to identifying the subset of edge nodes, the network device may receive the list of the one or more neighbor APs associated with the first AP and the network device may identify the subset of edge nodes as being associated with the one or more neighbor APs in the received list. In still more embodiments, the subset of edge nodes may include all those edge nodes that are associated with potential roaming candidate APs of the client device. In such embodiments, the identification of the subset of edge nodes may be based on a historical roaming pattern of the client device. In other words, prior to identifying the subset of edge nodes, the network device may receive the historical roaming pattern of the client device and predict a real-time or near real-time roaming pattern of the client device, identifying the potential roaming candidate APs of the client device, based on the historical roaming pattern. Thereafter, the network device may identify the subset of edge nodes coupled to the potential roaming candidate APs of the client device based on the predicted roaming pattern of the client device.

In yet more embodiments, the network device may be further configured to transmit at least one of the traffic steering policy context or the group tag context associated with the client device to the subset of edge nodes. For example, the network device may transmit either the traffic steering policy context, the group tag context, or both associated with the client device to the second edge node to which the client device is roaming to from the first edge node. In still various embodiments, the transmission of the traffic steering policy context and the group tag context to the second edge node may be prior to an arrival of network traffic associated with the client device at the second edge node. In further examples, the network device may transmit the traffic steering policy context and the group tag context associated with the client device to the subset of edge nodes associated with the one or more neighbor APs in the received list or the potential roaming candidate APs of the client device.

In additional embodiments, the transmission of the at least one of the traffic steering policy context or the group tag context to the subset of edge nodes may be independent of solicitation from the subset of edge nodes. In other words, the transmission of the traffic steering policy context and the group tag context to the subset of edge nodes may occur proactively, without requiring explicit requests from the subset of edge nodes, reducing latency and preventing disruptions. For example, in the wireless network, when the client device roams to a new edge node, the relevant traffic steering policies and group tag contexts (such as SIP to SGT mappings and DIP to DGT mappings associated with the client device) may be automatically pushed to the new edge node. That is to say, the transmission of the traffic steering policy context and/or the group tag context to the subset of edge nodes may be without solicitation from the subset of edge nodes.

In still further embodiments, the network device may transmit the traffic steering policy context and/or the group tag context as a part of client-context associated with the client device. For example, the traffic steering policy context and/or the group tag context may be transmitted using a vendor-specific Locator/ID Separation Protocol (LISP) Location-Class Attribute Format (LCAF) message format.

In numerous embodiments, the transmitted traffic steering policy context may include one or more configurations to steer network traffic of the client device. Further, the transmitted group tag context may include one or more DIP to DGT mappings, one or more SIP to SGT mappings, or both associated with the client device. In numerous additional embodiments, instead of transmitting all DIP to DGT mappings associated with the client device to the subset of edge nodes, the network device may be configured to transmit corresponding delta DIP to DGT mappings associated with the client device to each edge node of the subset of edge nodes. In other words, the transmitted group tag context may include one or more DIP to DGT mappings associated with the client device that are different between the first edge node and at least one edge node in the subset of edge nodes. For example, to transmit the corresponding delta DIP to DGT mappings to the second edge node, the network device may determine those DIP to DGT mappings associated with the client device that are different between the first edge node and the second edge node and transmit the delta DIP to DGT mappings. Likewise, the network device may transmit the corresponding delta DIP to DGT mappings to other edge nodes in the subset of edge nodes.

In several embodiments, the network device can proactively push either the traffic steering policy context, the group tag context, or both to multiple edge nodes upon initial onboarding of a very first client device belonging to a user group such as source group tag (SGT). For example, the network device that maintains the traffic steering policy context and the group tag context of client devices on a per-site basis may have knowledge of all edge nodes within that site. To prevent traffic disruption when a client device roams, the network device can distribute the traffic steering policy context and the group tag context to all edge nodes within the site based on the first client belonging to a specific user group being onboarded for traffic steering. This approach may eliminate the need for individual edge nodes to request the traffic steering policy context and the transmitted group tag context from the network device upon client device roaming, ensuring seamless handover. The traffic steering policy context and the transmitted group tag context is pushed once when the first client of the user group is onboarded, optimizing network efficiency.

In many further embodiments, an edge node device (for example, the second edge node device to which the client device is roaming to from the first edge node device) may be configured to receive, prior to an arrival of network traffic associated with the client device and without solicitation, at least one of the traffic steering policy context or the group tag context associated with the client device. The edge node device may further receive the network traffic from the client device and steer the received network traffic based on the received at least one of the traffic steering policy context or the group tag context. In many additional embodiments, the edge node device may further install the received at least one of the traffic steering policy context or the group tag context in an information database. In several other embodiments, the edge node device may be further configured to delete the received at least one of the traffic steering policy context or the group tag context from the information database based on the received at least one of the traffic steering policy context or the group tag context being unused for a configured time-period.

Thus, the edge-based roaming context management may offer significant advantages such as ensuring seamless connectivity and policy enforcement. The edge-based roaming context management may further ensure that the necessary traffic steering context information may be readily available at edge nodes when a client device roams across a wireless network. By proactively distributing traffic steering context information, delays associated with on-demand requests may be eliminated, reducing latency and improving network efficiency. The edge-based roaming context management may also enhance security by maintaining consistent traffic steering and access control policies, preventing unauthorized access or disruptions. Additionally, the edge-based roaming context management may optimize resource utilization on edge nodes, allowing for faster decision-making and a smoother user experience with minimal packet loss or service interruptions.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

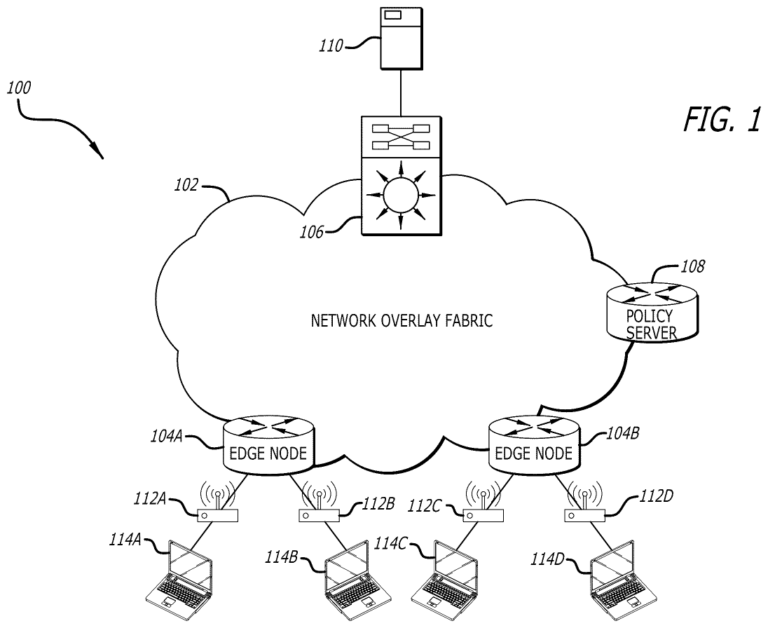

FIG. 1 is an illustrative representation of a network infrastructure arrangement 100 in a network of a network overlay fabric 102 in accordance with various embodiments of the disclosure is shown. Network overlay fabric 102 may include a plurality of network nodes, for example, routers, switches, or the like. The plurality of network nodes may be and/or be referred to as tunnel routers, each of which may be configured to perform a network overlay or “tunneling” protocol for establishing and maintaining network overlays or tunnels across the network of the network overlay fabric 102. In the example embodiment depicted in FIG. 1, the plurality of network nodes may include a first edge node 104A, a second edge node 104B, and a border node 106. The first edge node 104A and the second edge node 104B may be referred to as tunnel endpoints or “edge” tunnel routers, network access devices (NADs), or simply as “edge nodes”, whereas the border node 106.

In various embodiments, the network overlay fabric 102 may further include a policy server 108 that may be configured to define, manage, and enforce network policies across the network overlay fabric 102. In an example, the network policies may include a plurality of security policies unique to the network overlay fabric 102. In other words, the security policies may be different for different network overlay fabrics. In further examples, the policy server 108 can be an Identity Services Engine “ISE”, which manages and enforces the plurality of security policies across the network overlay fabric 102. The policy server 108 may act as a central authority for identity-based access control, providing visibility to a plurality of client devices in the network overlay fabric 102, and controlling access across wired, wireless, and virtual private network (VPN) connections.

In yet various embodiments, the network overlay fabric 102 may further include a service control plane device 110 (e.g., a device serving as a service control plane node) coupled to the network overlay fabric 102 via the border node 106. The service control plane device 110 may be configured to store traffic steering policy information to manage and control service-specific policies, routing, and traffic management for the network overlay fabric 102. In an example, the border node 106 may serve as an interface between the network overlay fabric 102 and service control plane device 110, forwarding control and data plane information. The border node 106 may communicate with the service control plane device 110 to dynamically apply policies such as access control, security, and traffic engineering to ensure optimal performance and security. The service control plane device 110 may utilize the border node 106 to distribute service-specific configurations, orchestrate service chains, and enforce end-to-end policies across the network overlay fabric 102.

In many embodiments, the network overlay fabric 102 may further include a plurality of access points (APs) 112A-112D. The plurality of APs 112A-112D may be further coupled to the first and second edge nodes 104A-104B. For example, APs 112A and 112B may be coupled to the first edge node 104A and APs 112C and 112D may be coupled to the second edge node 104B. “AP” may serve as an intermediary between a client device (e.g., smartphones, laptops, tablets, or Internet of Things “IoT” sensors) and a core network of the network overlay fabric 102.

As shown in FIG. 1, the plurality of APs 112A-112D may be further coupled to a plurality of client devices 114A-114D, respectively. The plurality of client devices 114A-114D may utilize one or more services offered by the network overlay fabric 102, and the plurality of APs 112A-112D may serve as intermediaries between the plurality of client devices 114A-114D and the core network for the plurality of client devices 114A-114D to utilize the one or more services of the network overlay fabric 102. The plurality of client devices 114A-114D may be associated with the plurality of APs 112A-112D via wireless fidelity “Wi-Fi”, 4G, 5G, 6G or higher frequency radio signals, which in turn may associate the plurality of client devices 114A-114D with corresponding first and second edge nodes 104A-104B. For example, client devices 114A and 114B may be associated with the first edge node 104A via the APs 112A and 112B, respectively. Likewise, client devices 114C and 114D may be associated with the second edge node 104B via the APs 112C and 112D, respectively.

In further embodiments, the plurality of client devices 114A-114D may be configured to register with the service control plane device 110 to provide their unique identifiers within the network. The identifiers may include endpoint identifiers (EIDs), destination Internet Protocol (DIP) addresses, source Internet Protocol (SIP), medium access control (MAC) addresses, or the like. The service control plane device 110 may utilize the registration information to maintain a comprehensive mapping of the plurality of client devices 114A-114D for network management and policy enforcement. In many further embodiments, the service control plane device 110 may register Layer 2 MAC addresses of the plurality of client devices 114A-114D, allowing the service control plane device 110 to track physical network addresses of the plurality of client devices 114A 114D for accurate traffic forwarding and segmentation. Additionally or alternatively, the service control plane device 110 may be configured to register Source Group Tags (SGTs) and Destination Group Tags (DGTs) for enforcing policy-based access control by associating each client device 114A-114D with specific security or service group classifications. In some implementations, the service control plane device 110 may be a shared server which is accessible to the plurality of client devices 114A-114D via the border node 106, which may be a remote extranet VPN.

In an example scenario, the service control plane device 110 may include a traffic context information database that may be configured to store information of the plurality of client devices 114A-114D and associated SGTs or DGTs. For example, the client devices 114A and 114C may be members of the same VPN (“VPN A”) and may be associated with “SGT A”. Similarly, the client devices 114B and 114D may be members of the same VPN (“VPN B”) and may be associated with SGT B. In further example scenario, the client device 114A may be associated with DGT A, the client device 114B may be associated with DGT B, the client device 114C may be associated with DGT C, and the client device 114D may be associated with DGT D.

The above associations of the plurality of the client devices 114A-114D may be maintained in the traffic context information database. More specifically, associations of the plurality of client devices 114A-114D may be maintained through their EIDs, DIPs, SIPs, or MAC addresses. In a non-limiting example, two host devices may be assigned to SGT A and two to SGT B, with corresponding DGT mappings for destination traffic. That is to say, the client device 114A may have an EID A (e.g., “192.168.1.100” or the like) mapped to SGT A, the client device 114B may have an EID B (e.g., “192.168.1.101” or the like) mapped to SGT B, the client device 114C may have an EID C (e.g., “192.168.1.102” or the like) mapped to SGT A, while the client device 114D may have an EID D (e.g., “192.168.1.103” or the like) mapped to SGT B. Similarly, for DIP to DGT mappings, the service control plane device 110 may maintain the client device 114A with DIP (192.168.1.100 or the like) mapped to DGT A, the client device 114B with DIP (192.168.1.101) mapped to DGT B, the client device 114C with DIP (192.168.1.102 or the like) mapped to DGT C, and the client device 114D with DIP (192.168.1.103 or the like) mapped to DGT D. In more embodiments, the service control plane device 110 may be further configured to allow the network overlay fabric 102 to enforce security policies based on EID-SGT mappings or DIP to DGT mappings of both source and destination devices for consistent and secure traffic handling.

In several embodiments, the plurality of client devices 114A-114D can roam between the plurality of APs 112A-112D distributed across the network, dynamically updating connections based on signal strength and mobility patterns. As a user moves, corresponding client device assesses available APs and transition to those APs that offer better connectivity and performance. In an example, a client device (any of the plurality of client devices 114A-114D) can roam from a first AP coupled to a first edge node to a second AP coupled to the same or a different edge node. If the second AP is associated with a different edge node such as a second edge node, the client device effectively transitions (roams) from being handled by the first edge node to being managed by the second edge node.

In order to mitigate the challenges for policy-driven traffic steering in a roaming scenario, the network overlay fabric 102 may include a network device (e.g., any of the service control plane device 110 or the policy server 108) that performs edge-based roaming context management, ensuring that a traffic steering policy context of the roaming client device, a group tag context of the roaming client device, or both are available at the “roamed to” edge node (e.g., the second edge node) prior to traffic of the roaming client device reaching the “roamed to” edge node. The network device can also be a Software-Defined Networking “SDN” Controller, a Service Function Chaining “SFC” Controller, a Network Orchestrator in Cloud, a Software-Defined Wide Area Network “SD-WAN”, or the like. The network device can also correspond to a cloud-based server. The network device may include a roaming management logic that may be configured to manage edge-based roaming context of one or more client devices in the network.

Those skilled in the art will recognize that the roaming management logic can include various hardware and/or software deployments and can be configured in a variety of ways. In many additional embodiments, the roaming management logic can be configured as a standalone device, exist as a logic in another network device or an edge-based network device or distributed among various network devices operating in tandem, or be remotely operated as part of a cloud-based network management tool to provide edge-based roaming context management of network traffic of the plurality of client devices 114A-114B. In many further embodiments, the roaming management logic can be provided as a cloud-based service that can service remote networks, such as, but not limited to the network of the network overlay fabric 102.

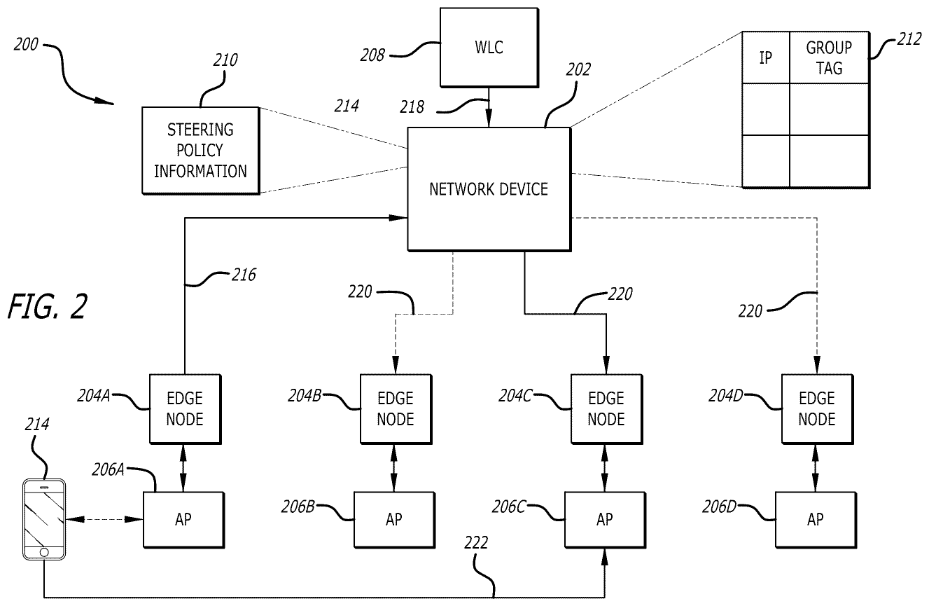

Although a specific embodiment for a network infrastructure arrangement 100 in a network of a network overlay fabric 102 suitable for carrying out the various steps, processes, methods, and operations described herein is discussed with respect to FIG. 1, any of a variety of systems and/or processes may be utilized in accordance with embodiments of the disclosure. In many non-limiting examples, the roaming management logic may be provided as a device or software separate from the network device or the roaming management logic may be integrated into a wireless LAN controller. The elements depicted in FIG. 1 may also be interchangeable with other elements of FIGS. 2-9 as required to realize a particularly desired embodiment.

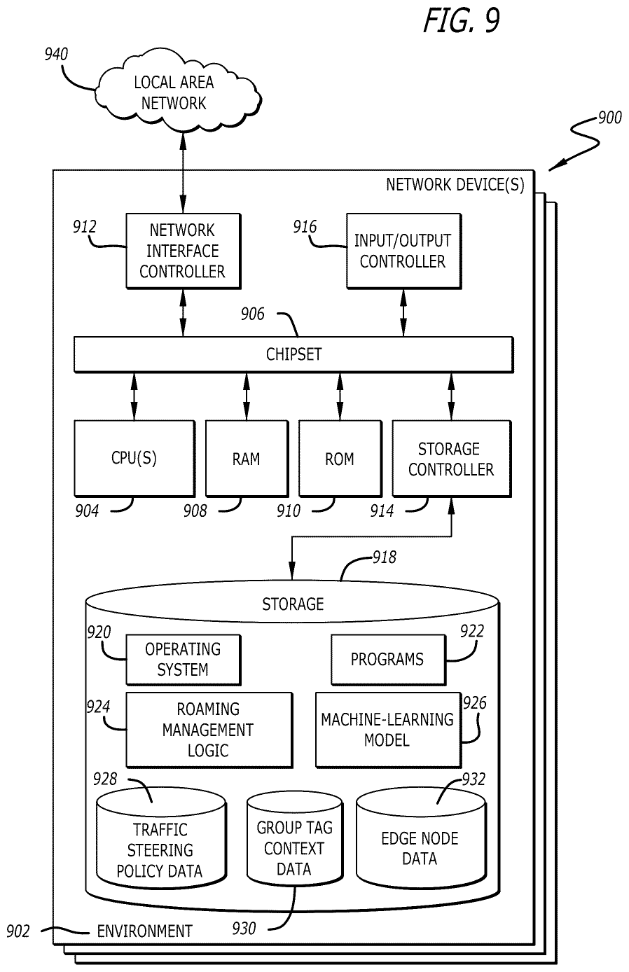

Referring to FIG. 2, a conceptual block diagram of a network fabric 200 highlighting policy-driven traffic steering in accordance with various embodiments of the disclosure is shown. The network fabric 200 may include a network device 202 that may be configured to implement edge-based roaming context management related to a plurality of client devices (e.g., smartphones, tablets, laptops, smartwatches, smart home sensors, smart appliances or the like) in the network fabric 200. In a non-limiting example, it may be assumed that the network device 202 is equipped with requisite hardware and software infrastructure to implement the edge-based roaming context management for seamless roaming experience in the network fabric 200. The network device 202 may also run a software stack that supports the edge-based roaming management. Additionally, the network device 202 may integrate with higher-level systems, such as network administration tools, network traffic steering systems, network slice selection systems or other network traffic management systems that may manage and enforce policies, authentication, resource allocation, or service quality across the network fabric 200. Examples of the network device 202 may include a service control plane device, a wireless local area network (LAN) controller (WLC), a service control plane server, a policy server, or the like. An example of the network device 202 is described later in conjunction with FIG. 9.

The embodiments shown in FIG. 2 may illustrate a scenario where edge-based roaming context management may be implemented by the network device 202 for a plurality of edge nodes 204A, 204B, 204C, 204D (collectively designated as “204A 204D”) in the network fabric 200. The plurality of edge nodes 204A-204D may be referred to as NADs. “NADs” may refer to hardware components, such as switches, routers, access points, or gateways, that regulate and manage client connectivity to a network while enforcing security and access policies. The plurality of edge nodes 204A-204D may be further coupled to corresponding plurality of APs 206A, 206B, 206C, 206D (collectively designated as “206A-206D”). The connection between the plurality of edge nodes 204A-204D and the corresponding plurality of APs 206A-206D can be wired, using Ethernet cables, or wireless through radio signals, leveraging Wi-Fi protocols. For example, a first edge node 204A may be connected to a first AP 206A. Similarly, a second edge node 204B may be connected to a second AP 206B, a third edge node 204C may be connected to a third AP 206C, and a fourth edge node 204D may be connected to a fourth AP 206D. Though different edge nodes are shown to be connected to different APs, the scope of the disclosure is not limited to it. In further embodiments, more than one AP can be coupled to an edge node.

In an example embodiment shown in FIG. 2, the network device 202 may be coupled to a WLC 208. The WLC 208 may be configured to centrally manage the plurality of APs 206A-206D including authentication, security policies, or traffic forwarding of a plurality of client devices in the network fabric 200 and may be further configured to assist the network device 202 to operate at a higher level, such as enforcing network-wide policies, quality of service (QoS), and traffic steering based on user profiles, application types, or network conditions. For example, in the network fabric 200, the WLC 208 may control and manage the plurality of APs 206A-206D, while the network device 202 may be configured to dynamically assign different bandwidth and routing policies to the plurality of client devices based on traffic steering policy information or group tag context of the plurality of client devices.

In the embodiment depicted in FIG. 2, the network device 202 may include a roaming management logic configured to implement the edge-based roaming context management. The roaming management logic can include various hardware and/or software deployments and can be configured in a variety of ways. For example, the roaming management logic can be a set of instructions stored within a non-volatile memory that, when executed by a processor(s) can carry out the steps for roaming context management. For the sake of ongoing description, operations performed by the roaming management logic are considered as performed by the network device 202 as the roaming management logic is included in or integrated with the network device 202.

In many further embodiments, the network device 202 may further include a steering policy information database 210 (indicated as “steering policy information” in FIG. 2) that may be configured to categorize the plurality of client devices, users, or applications based on predefined policies associated with network traffic steering of the plurality of client devices. That is to say, the steering policy information database 210 may include a set of traffic steering policy contexts. “Traffic steering policy context” may refer to a set of rules that may be utilized to direct network traffic of each of the plurality of client devices in the network fabric 200 to optimize performance, enforce security, or comply with pre-determined policies. The traffic set of steering policy contexts may include various configurations to steer network traffic of the plurality of client devices in the network fabric 200. The configuration(s) can include one or more traffic prioritization rules that determine which types of traffic, such as voice, video, or data, shall be given higher priority. The configuration(s) can further include one or more QoS parameters, specifying latency, jitter, and bandwidth allocation, one or more load balancing strategies, a path selection criteria, one or more security policies, or the like.

In several additional embodiments, the network device 202 may further include a group tag context database 212 that may store a variety of group tag contexts associated with the plurality of client devices. In many examples, the network device 202 may be configured to receive different types of requests from the plurality of edge nodes 204A-204D such as access requests, traffic routing requests, policy enforcement requests, or the like. The network device 202 may be further configured to maintain a plurality of Internet Protocol to group tag mappings associated with these requests. For example, the plurality of Internet Protocol to group tag mappings may include DIP to DGT mappings, SIP to SGT mappings, or the like. In an example, the DIP to DGT mappings, SIP to SGT mappings, or the like may correspond to the variety of group tag contexts maintained at the network device 202. DIP to DGT mapping may be utilized to associate an IP address with a predefined security or policy-based group tag. DIP to DGT mapping may allow an edge node to classify, enforce policies, and control traffic based on group-based access. For example, if a specific DIP belongs to a sensitive database, the DIP may be mapped to a high-security DGT, ensuring that only authorized source groups can communicate with the sensitive database. Further, SIP to SGT mapping may enable identification of which security group a source device belongs to, enabling policy-based access control.

In other words, “group tag context” may relate to a unique identifier (such as an SGT or a DGT) of each of the plurality of client devices, enabling policy-based access control and traffic management. “SGT” may refer to an identifier that represents a source group of each of the plurality of client devices within the network fabric 200. The SGT may be embedded in one or more network packets and may be utilized to enforce security policies and access controls based on the identity of the client device 214 each of the plurality of client devices (e.g., IP address, MAC address, or the like). “DGT” may refer to pointers to identify a security group of each of the plurality of client devices at a destination in the network fabric 200. Similar to SGTs, DGTs may be utilized in enforcing security policies and access controls. When a packet reaches an egress edge node (e.g., one of the plurality of edge nodes 204B-204D) of the network fabric 200, the DGT may be utilized to apply access control policies, ensuring that traffic is handled according to traffic steering policies.

The embodiments shown in FIG. 2 may illustrate a scenario where a client device 214 among the plurality of client devices in the network fabric 200 may be currently communicatively coupled to the first AP 206A. For the sake of brevity, the example embodiment shown in FIG. 2 highlights only one client device. APs 206B-206D may be neighboring APs of the first AP 206A. Network traffic from the client device 214 may be encapsulated by the first AP 206A. In a non-limiting example, when the client device 214 associated with the first AP 206A, a set of EID and SGTs mappings 216 may be stored in the group tag context database 212. “EID” of the client device 214 may refer to a unique identifier of the client device 214 in the network fabric 200. The EID may be an IP address, MAC address, or other identity attributes. For example, an SGT X may be assigned to EIDs associated with corporate laptops with specific MAC/IP addresses, while SGT Y may be assigned to guest users EIDs connected via guest Wi-Fi. Therefore, the set of EID-SGT mappings may refer to an association between the EID and SGT of the client device 214 within the network fabric 200. The set of EID—SGT mappings (or bindings) may be utilized to enforce security policies based on the EID of the client device 214. The set of EID-SGT mappings may be generated statistically through configuration commands or dynamically using a Security Group Exchange Protocol (SXP). With the set of EID-SGT mappings, steering policies associated with the client device 214 may be applied dynamically from the steering policy information database 210, ensuring guests cannot access internal resources while employees retain full access.

In a number of embodiments, the network device 202 may detect the client device 214 roaming from the first edge node 204A among the plurality of edge nodes 204A-204D. This detection may be based on one or roaming signals 218 that may include changes in authentication events, signal strength changes, MAC address tracking, or mobility protocols such as 802.11r (Fast Transition) or 802.1X re-authentication of the client device. The one or more roaming signals 218 may be transmitted to the network device 202 by the WLC 208, enabling the network device 202 to detect the client device 214 roaming from the first edge node 204A.

Upon detection of the client device 214 roaming from the first edge node 204A, in several additional embodiments, the network device 202 may identify a subset of edge nodes among the plurality of edge nodes 204A-204D to which the client device 214 can potentially roam to from the first edge node 204A. In one example embodiment, the subset of edge nodes may include at least the second edge node 204B to which the client device 214 may be roaming (or transitioning) to from the first edge node 204A. In several more embodiments, the identification of the subset of edge nodes may be based on a list of the neighbor APs 206B-206D associated with the first AP 206A received by the network device 202. That is to say, the neighbor APs 206B-206D associated with the first AP 206A may be potential roaming candidate APs for the client device 214.

In several embodiments, the neighbor APs 206B-206D, which may be potential roaming candidate APs for the client device 214, may be determined based on a predetermined range of proximity of the client device 214 to the neighbor APs 206B-206D. That is to say, not every neighbor AP associated with the first AP 206A may be included in the list of the neighbor APs, only the neighbor APs 206B-206D that are within the predetermined range of proximity of the client device 214 may be potential roaming candidate APs to which the client device 214 can potentially roam to. The neighbor APs 206B-206D may be further associated with the edge nodes 204B-204D, respectively. Thus, the network device 202 may identify, the edge nodes 204B-204D from among the plurality of edge nodes 204A-204D as the subset of edge nodes, as these edge nodes 204B-204D are associated with the neighbor APs 206B-206D in the received list. In the example embodiment shown in FIG. 2, for the sake of brevity, the subset of edge nodes is shown include three edge nodes 204B-204D associated with the neighbor APs 206B 206D. However, any number of edge nodes may be included in the subset of edge nodes.

In yet more embodiments, the network device 202 may transmit either a traffic steering policy context, a group tag context, or both (indicated as arrow 220) associated with the client device 214 to the subset of edge nodes 204B-204D. Prior to transmission of the traffic steering policy context and/or the group tag context to the subset of edge nodes 204B-204D, the network device 202 may identify the traffic steering policy context or the group tag context associated with the client device 214 from the steering policy information database 210 and the group tag context database 212, respectively. In other words, the network device 202 may ensure that the traffic steering policy context or the group tag contexts of the client device 214 may reach the subset of edge nodes 204B 204D before the client device 214 actually roams to one of the edge nodes (e.g., the second edge node 204B) among the subset of edge nodes 204B-204D and prior to arrival of network traffic to the second edge node 204B. In other words, when the client device 214 decides to roam (indicated by arrow 222) to a new edge node (e.g., another edge node device than the first edge node 204A such as the second edge node 204B), the relevant traffic steering policies context and/or the group tag context (such as SGTs for access control and DGTs for traffic steering) may already be in place in the second edge node 204B without being requested by the second edge node 204B. In fact, even the remaining subset of edge nodes 204C and 204D may also receive the same traffic steering policy context and the group tag context (indicated by arrows 220) of the client device 214 in anticipation that the client device 214 may decide to roam to the edge nodes 204C or 204D. That is to say, the transmission of the at least one of the traffic steering policy context or the group tag context to the subset of edge nodes 204B-204D may be independent of (e.g., without) solicitation from the subset of edge nodes 204B-204D.

In still further embodiments, the network device 202 may be configured to transmit the at least one of the traffic steering policy context or the group tag context as a part of client-context associated with the client device 214. For example, the at least one of the traffic steering policy context or the group tag context may be transmitted using a vendor-specific Locator/ID Separation Protocol (LISP) Location-Class Attribute Format (LCAF) message format. The vendor-specific LISP LCAF message format may correspond to an extension of the LISP protocol that enables encoding of additional metadata, such as the traffic steering policy context and/or the group tag context, in LISP control messages. The LCAF format may allow vendors to define custom attributes for traffic engineering, policy enforcement, and hierarchical addressing. This format may support proprietary extensions within LISP-encapsulated traffic, enhancing control over routing decisions. Thus, the network device 202 may facilitate a seamless handoff by maintaining session continuity, updating security policies, and ensuring the client device 214 retain access to authorized network resources without interruption.

Although a specific embodiment for a network fabric 200 highlighting policy-driven traffic steering suitable for carrying out the various steps, processes, methods, and operations described herein is discussed with respect to FIG. 2, any of a variety of systems and/or processes may be utilized in accordance with embodiments of the disclosure. For example, the network device 202 may receive a historical roaming pattern of the client device 214 from the WLC 208 based on which the network device 202 may predict a real-time or near-real-time roaming pattern of the client device 214. That is to say, the roaming pattern of the client device 214 may help in predicting to which subset of edge nodes 204B-204D among the plurality of edge nodes the client device 214 can potentially roam to. The network device 202 may, thus, identify the subset of edge nodes 204B-204D among the plurality of edge nodes 204A-204D based on the roaming pattern of the client device 214. In further more embodiments, the network device 202 may transmit at least one of the traffic steering policy context or the group tag context associated with the client device 214 to the subset of edge nodes 204B-204D identified based on the predicted roaming pattern. The elements depicted in FIG. 2 may also be interchangeable with other elements of FIGS. 1 and 3-9 as required to realize a particularly desired embodiment.

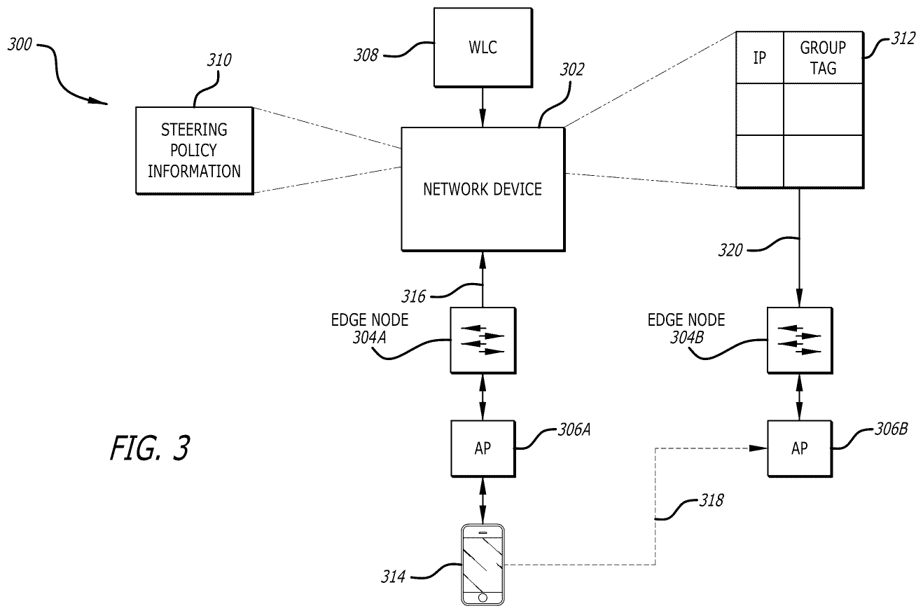

Referring to FIG. 3, a conceptual diagram that illustrates a network fabric 300 utilized in network traffic policy steering and service mapping in accordance with various embodiments of the disclosure is shown. The network fabric 300 may include a network device 302 (e.g., a service control plane device, a WLC, a service control plane server, a policy server, or the like). The network device 302 may be configured to manage and enforce various tasks such as policies, authentication, resource allocation, and service quality across the network fabric 300 while separating the tasks from a data plane, which manages actual data transmission.

In an example embodiment illustrated in FIG. 3, edge nodes 304A-304B may be coupled to the network device 302. Examples of the edge nodes 304A-304B may include routers, switches, APs, cellular base stations, IoT gateways, or Multi-access Edge Computing (MEC) servers. A first edge node 304A may be further coupled to a first AP 306A via a tunnel to route network traffic to/from the first AP 306A. Similarly, a second edge node 304B may be coupled to a second AP 306B. The network device 302 may be further communicatively coupled to a WLC 308 that may be configured to further manage and enforce network traffic policies of the network fabric 300 via the network device 302. The WLC 308 may perform tasks such as overseeing authentication, roaming, QoS, and security policies managed by the network device 302 to ensure seamless connectivity and secure access.

Additionally or alternatively, the network device 302 may feature a steering policy information database 310, for categorizing a plurality of client devices (e.g., smartphones, tablets, laptops, smartwatches, smart home sensors, or smart appliances) in the network fabric 300 based on predefined traffic steering policies. The steering policy information database 310 may include subscriber profiles, QoS parameters, application-specific policies, network slicing configurations, traffic prioritization rules, handover policies, and real-time network conditions. For example, in a 5G network, the steering policy information database 310 may store rules to steer video streaming traffic over a low-latency network slice while directing bulk data transfers through a high-throughput but non-latency-sensitive path to optimize performance.

The network device 302 may be coupled or integrated with a group tag context database 312. The group tag context database 312 may include unique identifiers, such as an SGTs or DGTs mapped to the plurality of client devices in the network fabric 300. The group tag context database 312 may also include DIP to DGT mappings, which can vary between the first edge node 304A and the second edge node 304B. The variations in DIP to DGT mappings may be referred to as delta mappings that may be utilized to optimize the edge-based roaming context management of network traffic in the network fabric 300.

In the example embodiment shown in FIG. 3, a client device 314 among the plurality of client devices, may be currently connected to the first AP 306A. Network traffic from the client device 314 may be encapsulated by the first AP 306A, which may further establish a tunnel to the first edge node 304A to route the network traffic of the client device 314. Similarly, the second AP 306B to which the client device 314 may eventually roam to may be associated with the second edge node 304B.

The embodiments illustrated in FIG. 3 demonstrates a scenario where edge-based roaming context management is implemented with respect to the second edge node 304B. In an example, the client device 314 can roam from the first AP 306A coupled to the first edge node 304A to the second AP 306B coupled to a different edge node, e.g., the second edge node 304B. Since the second AP 306B is associated with a different edge node such as the second edge node 304B, the client device 314 effectively transitions (roams) from being handled by the first edge node 304A to being managed by the second edge node 304B. In other words, the second edge node 304B may refer to a fabric edge node to which the client device 314 may roam to based on (re)association with the second AP 306B.

In this example, the second edge node 304B may be designed with the required hardware and software to facilitate seamless roaming for the client device 314. The second edge node 304B may operate a software stack that enables edge-based roaming context management and seamlessly integrates with higher-level network infrastructure, including network administration tools, traffic optimization systems, and policy enforcement frameworks. These integrated systems work together to handle authentication, allocate resources, and maintain service quality across the network fabric 300, ensuring smooth service delivery through signaling, orchestration, and control processes. The second edge node 304B may further include a roaming management logic configured to implement the edge-based roaming context management. For the sake of ongoing description, operations performed by the roaming management logic are considered as performed by the second edge node 304B as the roaming management logic is included in or integrated with the second edge node 304B.

To maintain consistent policy enforcement, when the client device 314 connects to the first AP 306A, a set of EID-SGT mappings 316 may be stored in the group tag context database 312. The group tag context database 312 may include a matrix of rows and columns for storing group tag context information associated with a plurality of client devices such the client device 314. Each row may signify an ID of a particular client device, whereas each column may signify a particular context information associated with a predetermined edge node. The cross over between a row and a column may provide a set of mappings between the client device and the group tag context information. For example, the set of EID-SGT mappings 316 may be obtained, for example, from a predetermined row of the group tag context database 312. Further, a set of DIP-DGT mappings or a set of delta mappings may further be stored in the group tag context database 312.

In an example embodiment shown in FIG. 3, in a variety of embodiments, prior to an arrival of network traffic 318 associated with the client device 314, the second edge node 304B may receive at least one of a traffic steering policy context associated with the client device 314 from the steering policy information database 310 or a group tag context associated with the client device 314 from the group tag context database 312. That is to say, the second edge node 304B may receive the traffic steering policy context or the group tag context from the network device 302. The received at least one of the traffic steering policy context associated with the client device 314 or the group tag context associated with the client device 314 is shown by way of arrow 320 in FIG. 3. In an example embodiment, the network device 302 may be configured to receive the information regarding a subset of edge nodes, e.g., the second edge node 304B, or the second AP 306B that corresponds to a roaming target of the client device 314.

In more embodiments, the traffic steering policy context or the group tag context may be received unsolicited by the second edge node 304B. In other words, the second edge node 304B may receive the traffic steering policy context or the group tag context associated with the client device 314 without sending any request to the network device 302 for the corresponding the traffic steering policy context or the group tag context.

In several embodiments, the second edge node 304B may receive the network traffic 318 from the client device 314 after receiving the traffic steering policy context or the group tag context associated with the client device 314. The second edge node 304B may be configured to steer the received network traffic based on the received the traffic steering policy context or the group tag context. That is to say, after receiving the traffic steering policy or the group tag context, the second edge node 304B may enforce the traffic steering policy by directing traffic based on predefined rules and security segmentation. Additionally, the group tag context may further enable identity-based access control by associating traffic with SGTs or DGTs for the client device 314 with an EID or a DIP, allowing segmentation between different user groups (e.g., employees, guests, IoT devices). For example, if the client device 314 is an IoT device that has an SGT of “IoT-Sensors”, network traffic of the IoT device can be restricted from accessing employee systems (e.g., DGT: Corporate-Devices) but allowed to communicate with a cloud analytics service (e.g., DIP: 192.168.1.100). Similarly, guest users (e.g., SGT: Guest-Users) can be prevented from accessing internal servers while allowing internet access. Thus, utilizing either the received traffic steering policy context, the group tag context, or both, the second edge node 304B may ensure that the network traffic 318 of the client device 314 may be forwarded to the appropriate destinations while maintaining compliance with security policies and network performance requirements.

In additional embodiments, the second edge node 304B may install the received traffic steering policy context or the group tag context in an information database (e.g. a Forward information base “FIB”, a routing information base “RIB”, or the like).

For example, when the client device 314 or client devices similar to the client device 314, or a client device pertaining to a user group associated with the client device 314 roams to the second edge node 304B, the second edge node 304B receives the traffic steering policy context and/or the group tag context of the client device 314 without solicitation and installs the received traffic steering policy context or the group tag context in the information database like FIB or RIB. Thus, avoiding potential delay, packet loss, or service interruptions, and allowing the second edge node 304B to lookup and enforce routing decisions or access control without querying the network device 302. In several additional embodiments, the second edge node 304B may further delete the received at least one of the traffic steering policy context or the group tag context from the information database based on the received at least one of the traffic steering policy context or the group tag context being unused for a configured time-period. This ensures that only relevant, recent, and actively utilized contexts are retained, preventing unnecessary storage overhead.

Although a specific embodiment for network fabric 300 utilized in network traffic policy steering and service mapping suitable for carrying out the various steps, processes, methods, and operations described herein is discussed with respect to FIG. 3, any of a variety of systems and/or processes may be utilized in accordance with embodiments of the disclosure. For example, instead of receiving all DIP to DGT mappings associated with the client device 314, the second edge node 304B may be configured to receive one or more DIP to DGT mappings associated with the client device that are different between the first edge node 304A and the second edge node 304B. The elements depicted in FIG. 3 may also be interchangeable with other elements of FIGS. 1-2 and 4-9 as required to realize a particularly desired embodiment.

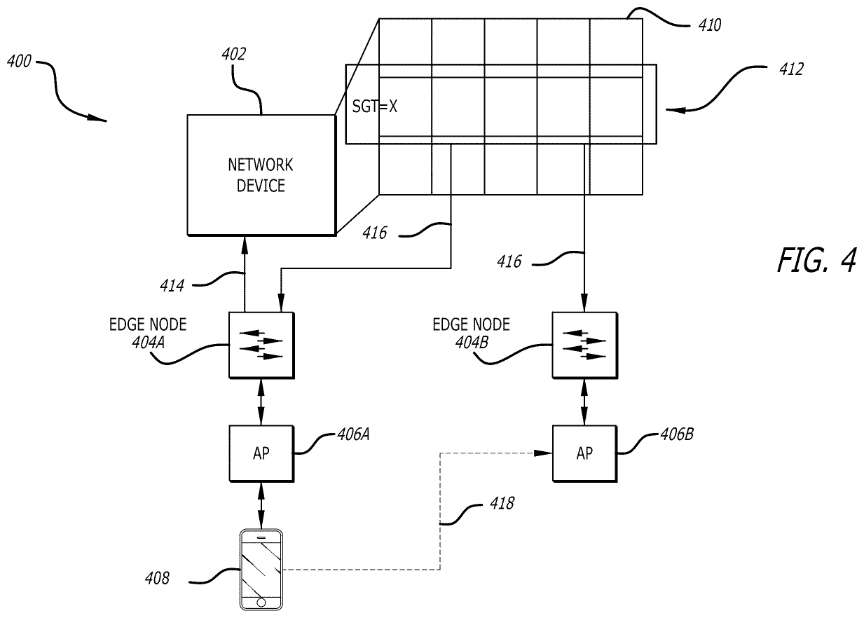

Referring to FIG. 4, a conceptual diagram that illustrates a network fabric 400 utilized in edge-based roaming context management per network site in accordance with various embodiments of the disclosure is shown. The network fabric 400 may include a network device 402 (e.g., a service control plane device, a WLC, a service control plane server, a policy server such as an Identity Services Engine, or the like) configured to enforce network policies by managing QoS, access control, traffic steering or subscriber-specific rules based on real-time conditions and predefined policies. The network device 402 may be coupled to a first edge node 404A and a second edge node 404B. The first edge node 404A and a second edge node 404B may be further associated with a first AP 406A and a second ap 406B, respectively.

In numerous additional embodiments, edge-based roaming context management may be implemented on the network device 402. The network device 402 may include a context information database 410 configured to store traffic steering policy context and/or group tag context associated with a plurality of client devices across the network fabric 400. Further, the traffic steering policy may be maintained on a per-site basis for the network fabric 400. That is to say, the traffic steering policy may be different for a different site or a different network fabric.

In additional embodiments, a client device 408 may pertain to a user group which may also include additional client devices. The user group may correspond to a predetermined SGT. For example, the client device 408 may belong to a user group for an SGT=X associated with an organization that may include multiple client devices, such as laptops, smartphones, and tablets used by employees within the organization. The context information associated with SGT X may already be stored in a particular location 412 of the context information database 410.

The embodiments illustrated in FIG. 4 demonstrates a scenario where the client device 408 associates with the first AP 406A and requests 414 for at least one of a traffic steering policy context and a group tag context from the network device 402 via the first AP 406A and the first edge node 404A. Upon receiving the request 414, in several embodiments, the network device 402 may determine whether the client device 408 is the first client device of the user group SGT X that is requesting for the traffic steering policy context and the group tag context. In other words, the network device 402 may determine if a request for traffic steering policy context and group tag context has previously been received from another member of the same user group to which the client device 408 belongs.

If the network device 402 determines that no request for traffic steering policy context and group tag context has been received previously for the user group to which the client device 408 belongs, the network device 402 may be configured to proactively push either the traffic steering policy context, the group tag context, or both to multiple edge nodes in the given site. For example, as the given site includes the first edge node 404A and the second edge node 404B and the network device 402 has knowledge of all edge nodes (e.g., the first edge node 404A and the second edge node 404B) within that site, the network device 402 may be configured to distribute/transmit the traffic steering policy context and the group tag context, pertaining to the group tag SGT X, to the first edge node 404A and the second edge node 404B (indicated by arrows 416). This approach may eliminate the need for individual edge nodes to request the traffic steering policy context and the transmitted group tag context from the network device 402 upon client device roaming, ensuring seamless handover. The traffic steering policy context and the transmitted group tag context thus is pushed once when an initial client of a user group is onboarded at an edge node, optimizing network efficiency.

Further, network traffic from the client device 408 may then be encapsulated by the first AP 406A and transferred to the first edge node 404A for routing or steering. In further embodiments, if the client device 408 roams from the first edge node 404A to the second edge node 404B, the second edge node 404B already has the traffic steering policy context and the transmitted group tag context related to the client device 408 even before network traffic 418 from the client device 408 reaches the second edge node 404B.

Although a specific embodiment for network fabric 400 utilized in edge-based roaming context management per network site suitable for carrying out the various steps, processes, methods, and operations described herein is discussed with respect to FIG. 4, any of a variety of systems and/or processes may be utilized in accordance with embodiments of the disclosure. For example, the network device 402 may direct the at least one of the traffic steering policy context or the group tag context to a plurality of NADs in the network fabric 400 only once for the user group when the client device 408 of the user group is onboarded as the first client device of the user group even before a roaming event is detected. The elements depicted in FIG. 3 may also be interchangeable with other elements of FIGS. 1-3 and 5-9 as required to realize a particularly desired embodiment.

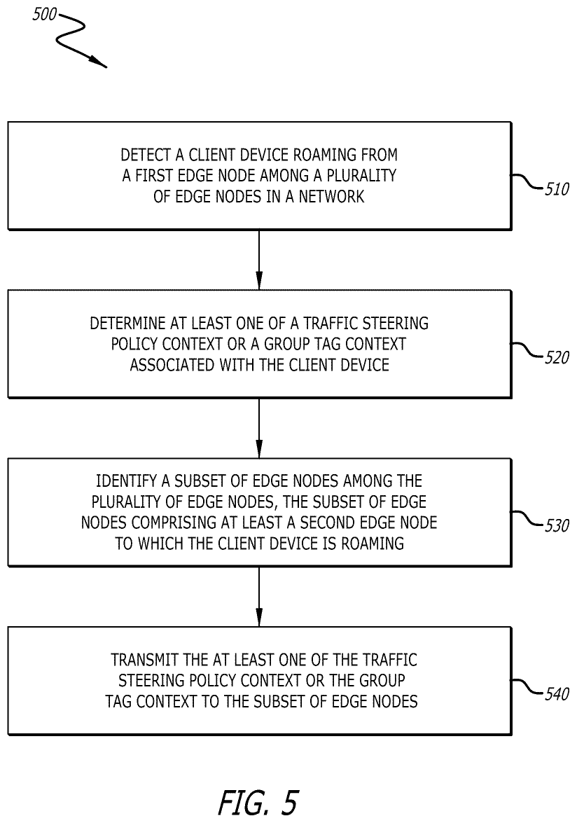

Referring to FIG. 5, a flowchart depicting a process 500 for edge-based roaming context management in accordance with various embodiments of the disclosure is shown. In many embodiments, the edge-based roaming context management may be performed at a network device (e.g., a service control plane device, a policy control plane server, a policy server, or the like) associated with a network. In further embodiments, the process 500 may detect a client device roaming from a first edge node among a plurality of edge nodes in a network (block 510). In other words, the process 500 may monitor the network for client device movement across different edge nodes. Thus, when a client device moves out of the coverage area of its currently associated AP, a handoff may be initiated to a new AP that may be connected to a different edge node. The process 500 may detect the transition by analyzing various signals, such as changes in Received Signal Strength Indicator (RSSI), authentication requests at the new AP, or mobility events triggered by different protocols (e.g., 802.11k/v/r).

In a number of embodiments, the process 500 may determine at least one of a traffic steering policy context or a group tag context associated with the client device (block 520). Traffic steering policy context may define how network traffic from the client device may be routed through one or more security services, such as firewalls or proxies, while group tag contexts (e.g., SGTs or DGTs) may classify the client device for policy enforcement. In several embodiments, the group tag context may include one or more DIP to DGT mappings associated with the client device. In several additional embodiments, the group tag context may include one or more DIP to DGT mappings associated with the client device that are different between the first edge node and at least one edge node in the subset of edge nodes. In yet several embodiments, the traffic steering policy context may include one or more configurations to steer network traffic of the client device. The determination may ensure that the security, QoS, or access policies of the client device remain intact as the client device transitions between edge nodes.

In a variety of embodiments, the process 500 may identify a subset of edge nodes among the plurality of edge nodes, the subset of edge nodes comprising at least a second edge node to which the client device is roaming (block 530). That is to say, the process 500 may select the subset of edge nodes as relevant edge nodes that need to receive the traffic steering policy or the group tag context of the client device. The subset of edge nodes may be selected from a larger pool of available edge nodes to optimize service continuity and performance for the roaming client device. The second edge node among the subset of edge nodes may be a target node to which the client device is transitioning. The selection process of the second edge node may consider factors such as network topology, latency, load balancing, or service requirements to ensure that session data, application state, or user context is preloaded or migrated to the second edge node. The identification of the subset of edge nodes may be further based on factors such as historical roaming patterns, network topology, proximity to the current location of the client device, or the like.

In more embodiments, the process 500 may transmit the at least one of the traffic steering policy context or the group tag context to the subset of edge nodes (block 540). That is to say, when traffic of the client device reaches a new edge node (e.g., the second edge node) among the subset of edge nodes, the relevant traffic steering policy context and the group tag context of the client device may already be present with the second edge node without any solicitation from any of the subset of edge nodes. In other words, the transmission of the at least one of the traffic steering policy context or the group tag context to the second edge node is prior to an arrival of network traffic associated with the client device at the second edge node. In other words, the transmission of the at least one of the traffic steering policy context or the group tag context to the second edge node may be prior to the arrival of network traffic associated with the client device at the second edge node. In still further embodiments, the traffic steering policy context or the group tag context may be transmitted as a part of client-context associated with the client device. For example, the at least one of the traffic steering policy context or the group tag context may be transmitted using a vendor-specific LISP, LCAF, or any other message format.

Although a specific embodiment for roaming context management suitable for carrying out the various steps, processes, methods, and operations described herein is discussed with respect to FIG. 5, any of a variety of systems and/or processes may be utilized in accordance with embodiments of the disclosure. For example, the subset of edge nodes may be identified based on a list of one or more neighboring APs associated with an AP that the client device may be currently communicatively coupled to. The elements depicted in FIG. 5 may also be interchangeable with other elements of FIGS. 1-4 and 6-9 as required to realize a particularly desired embodiment.

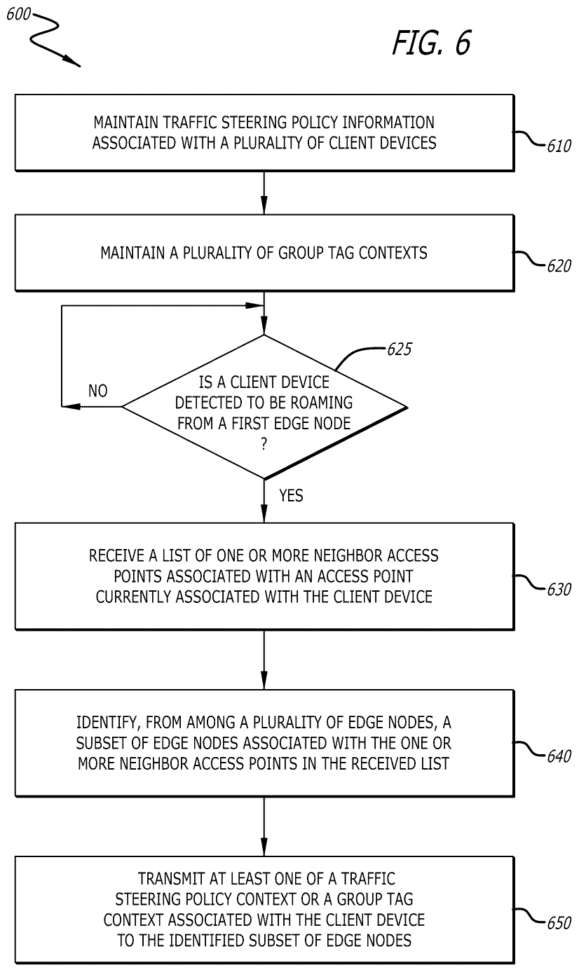

Referring to FIG. 6, a flowchart depicting a process 600 for transmission of traffic steering policy context or group tag context in accordance with various embodiments of the disclosure is shown. The process 600 may be performed at a network device (for example, a service control pane device, a WLC, a policy server, or the like) associated with a wireless network. In many embodiments, the process 600 may maintain traffic steering policy information associated with a plurality of client devices (block 610). A network traffic steering policy may include one or more steering configurations that may serve domain name system (DNS) requests, provide failover capabilities, load balance traffic across multiple network devices, or provide steering mechanisms to steer network traffic. In other words, the network traffic steering policy may define how network traffic may be routed based on factors like bandwidth usage, priority levels, or security constraints. For example, in an enterprise network, corporate laptops may be assigned a high-priority traffic steering policy to ensure seamless access to business-critical applications, while guest devices may be routed through a lower-priority network segment with restricted access.

In a number of embodiments, the process 600 may maintain a plurality of group tag contexts (block 620). Group tag contexts may be a way to organize and categorize a plurality of tags in a hierarchical, priority-based or a predetermined structure based on EID or DIPs corresponding to a plurality of client devices in the wireless network. The plurality of group tags may be utilized to enforce network segmentation, security policies, or traffic prioritization. For example, the plurality of group tags may include SGT or DGT, EID to SGT mappings, DIP to DGT mappings or the like. SGTs may be utilized to enforce security policies associated with the SGTs and ensure that network traffic may be routed and processed according to the security policies while DGTs may be utilized in categorizing and prioritizing traffic based on various criteria such as source, destination, application type, or security policies. The EID to SGT mappings may be utilized to map an EID corresponding to a client device that may require a particular security policy and thus may be mapped to the SGT providing the particular security policy.

In more embodiments, the process 600 may determine whether a client device is detected roaming from a first edge node among a plurality of edge nodes (block 625). That is to say, the process 600 may monitor client device movement across different edge nodes. In other words, when the client device moves from the first edge node to another, the process 600 may proceed to handle the roaming event of the client device. If the process 600 does not detect the client device roaming from the first edge node, the process 600 may continue monitoring network traffic (block 625).

In yet more embodiments, if the process 600 detects that the client device is roaming from the first edge node, the process 600 may receive a list of one or more neighbor access points associated with the access point corresponding to the client device (block 630). The list of the one or more neighbor APs may be generated based on a proximity of the one or more neighbor APs with the client device.

In additional embodiments, the process 600 may identify, from among the plurality of edge nodes, a subset of edge nodes associated with the one or more neighbor APs in the received list (block 640). Each AP in the network may be mapped to respective edge nodes, and the process 600 may identify the subset of edge nodes responsible for the potential connection points of the client device. For example, if a mobile user in a corporate campus moves from AP-1 (linked to Edge Node A) to AP-2 (linked to Edge Node B), the process 600 may identify Edge Node B as the next responsible egress node. That is to say, the subset of edge nodes may be egress nodes associated with the one or more neighbor APs that may be potential roaming candidates for the client device based on which network traffic may be directed to.

In further embodiments, the process 600 may transmit at least one of a traffic steering policy context or a group tag context associated with the client device to the identified subset of edge nodes (block 650). In other words, the transmission of the at least one of the traffic steering policy context or the group tag context associated with the client device is based on the identification of the subset of edge nodes. The process 600 may proactively transmit the traffic steering policy or the group tag context that may be independent of solicitation from the subset of edge nodes. That is to say, the process 600 may proactively transmit traffic steering policies or group tag contexts to the relevant edge nodes (e.g., the subset of edge nodes) without solicitation (e.g., without waiting for a request) from the subset of edge nodes. Thus, when the client device roams, the process 600 may anticipate the movement and may push the necessary traffic steering policy and the group tag contexts to the subset of edge nodes associated with the one or more neighboring APs. By doing so, the process 600 may ensure that policy enforcement, access control, and traffic prioritization are already in place before the client device connects to a new edge node among the subset of edge nodes.

Although a specific embodiment for transmission of traffic steering policy or group tag contexts suitable for carrying out the various steps, processes, methods, and operations described herein is discussed with respect to FIG. 6, any of a variety of systems and/or processes may be utilized in accordance with embodiments of the disclosure. For example, the traffic steering policy or the group tag context may be solicited by an edge node to which the client device is roaming to before traffic from the client device reaches the edge node. The client device may be a first device among a plurality of client devices of a user group that may be roaming to the edge node. As a result, the process 600 may transmit the traffic steering policy or the group tag context to the edge node only once for the plurality of client devices of the user group at the time of transmission of the traffic steering policy or the group tag context for the first client device. The elements depicted in FIG. 6 may also be interchangeable with other elements of FIGS. 1-5 and 7-9 as required to realize a particularly desired embodiment.

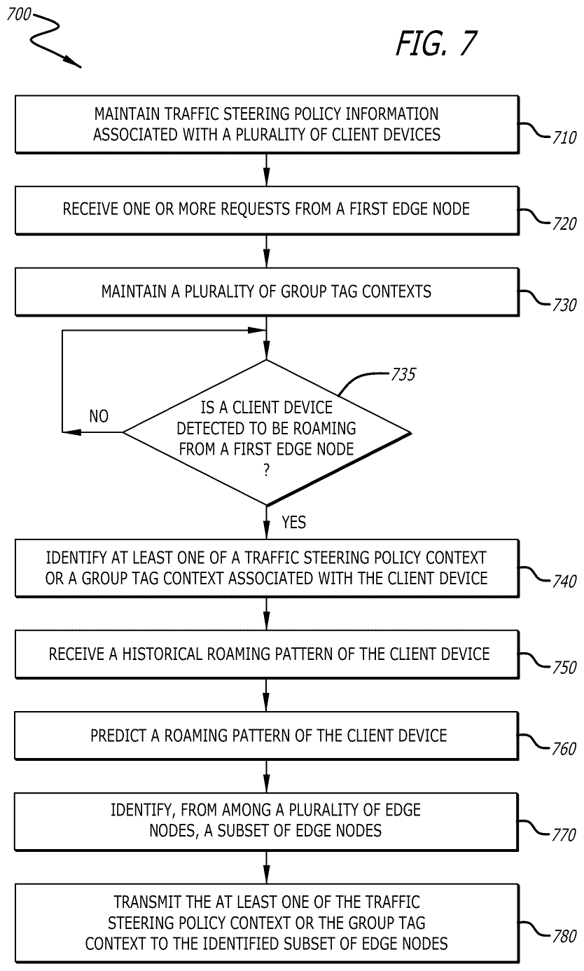

Referring to FIG. 7, a flowchart depicting a process 700 for roaming pattern based roaming context management in accordance with various embodiments of the disclosure is shown. A network device, such as a service control plane device, a WLC, a policy server or the like, associated with a plurality of edge nodes in a network. The network device may be equipped with a roaming management logic configured to utilize roaming pattern of client devices for facilitating edge-based roaming context management. In many embodiments, the process 700 may maintain traffic steering policy information associated with a plurality of client devices (block 710). The traffic steering policy may be stored in a predetermined format in a database, a server or ISE associated with the service control plane device such that when an edge node requires a traffic steering policy associated with a client device or a plurality of client devices of a particular user group, the traffic steering policy may be easily fetched from the database when a client device roams.

In many further embodiments, the process 700 may receive one or more requests from a first edge node (block 720). The process 700 may receive the one or more requests from the first edge node when a client device roams to the first edge node. The one or more requests may include information about the identity of the client device (e.g., EID), or other policy-related data associated with the EID.

In a number of embodiments, the process 700 may maintain a plurality of group tag contexts (block 730). That is to say, the process 700 may be further associated with a database, or a server that may include group tag contexts, which map different destination IP addresses to specific group tags (e.g., EIDs to SGTs or DIPs to DGTs). In other words, the group tag context associated with a client device may include one or more DIP to DGT mappings of the plurality of DIP to DGT mappings. The group tag contexts may be utilized for classifying network traffic for routing and security purposes based on the one or more requests from the first edge node. By maintaining a plurality of group tag contexts for a plurality of client devices based on the one or more requests by the first edge node, the process 700 may enable various traffic categories, such as corporate, guest, and IoT traffic, to be steered to the specified routes seamlessly without any packet loss or delay for subsequent edge nodes to which the client device or the plurality of client devices may roam to from the first edge node.

In more embodiments, the process 700 may determine whether a client device is detected roaming from the first edge node (block 735). The first edge node may be associated with an AP the client device is currently in communication with. The process 700 may monitor the network for any sign of movement from the client device from the AP in the network. If the client device stays in the first edge node associated with the AP, the process 700 may continue monitoring the network for any possible roaming event of the client device (block 735).

However, if the process 700 detects that the client device has roamed from the first edge node, in further embodiments, the process 700 may identify at least one of a traffic steering policy context or a group tag context associated with the client device (block 740). That is to say, the process 700 may identify traffic steering policies associated with the client device or group tags such as SGT or DGTs associated with the client device that may be maintained at the network device based on the one or more requests from the first edge node. For example, the process 700 may identify DIP to DGT mappings that may be essential for enforcing security policies of the client device in the network. By identifying DIPs to DGTs, access control policies based on the SGT of the client device can be applied at the edge node to which the client device is roaming to from the first edge node.

In further additional embodiments the process 700 may receive a historical roaming pattern of the client device (block 750). That is to say, the process 700 may track a movement of the client device, roaming from one AP to another AP and store data associated with the tracked movement. Thus, the stored data over a pre-determined time-period (e.g., one or more days, one or more months or the like) may comprise the historical roaming pattern of the client device.

In still further embodiments, the process 700 may predict a roaming pattern of the client device based on the historical roaming pattern (block 760). That is to say, the historical roaming pattern may be utilized to understand a common roaming behavior and preferred APs of the client device and thus predict the roaming pattern of the client device. In still more embodiments, the process 700 may utilize machine learning or artificial intelligence models that may learn from the historical roaming pattern of the client device and generate one or more roaming patterns of the client device. In a non-limiting example, the generated one or more roaming patterns may be utilized to train the service control plane device to predict accurate roaming path of the client device.

In several more embodiments, the process 700 may identify, from among the plurality of edge nodes, the subset of edge nodes based on the roaming pattern of the client device (block 770). That is to say, based on the roaming pattern predicted, the process 700 may identify the subset of edge nodes associated with respective potential APs that the client device may roam to. Thus, the subset of edge nodes may be selected that may be most likely to be involved in the future roaming events of the client device.

In numerous additional embodiments, the process 700 may transmit at least one of a traffic steering policy context or the identified group tag context associated with the client device to the identified subset of edge nodes (block 780). In other words, the transmission of the at least one of the traffic steering policy context or the group tag context associated with the client device is based on the identification of the subset of edge nodes. In many further embodiments, the traffic steering policy information may include the traffic steering policy context of the client device. Regardless of whether the transmission by the subset of edge nodes was solicited or unsolicited by the subset of edge nodes, the process 700 may transmit the relevant traffic steering policy context or group tag context to the designated subset of edge nodes. This transmission provides the subset of edge nodes with the necessary information to handle incoming client traffic appropriately.

Although a specific embodiment for roaming pattern based roaming management suitable for carrying out the various steps, processes, methods, and operations described herein is discussed with respect to FIG. 7, any of a variety of systems and/or processes may be utilized in accordance with embodiments of the disclosure. For example, the transmission of traffic steering policy or identified group tag context may take place for a plurality of client devices roaming in the network. The elements depicted in FIG. 7 may also be interchangeable with other elements of FIGS. 1-6, 8, and 9 as required to realize a particularly desired embodiment.

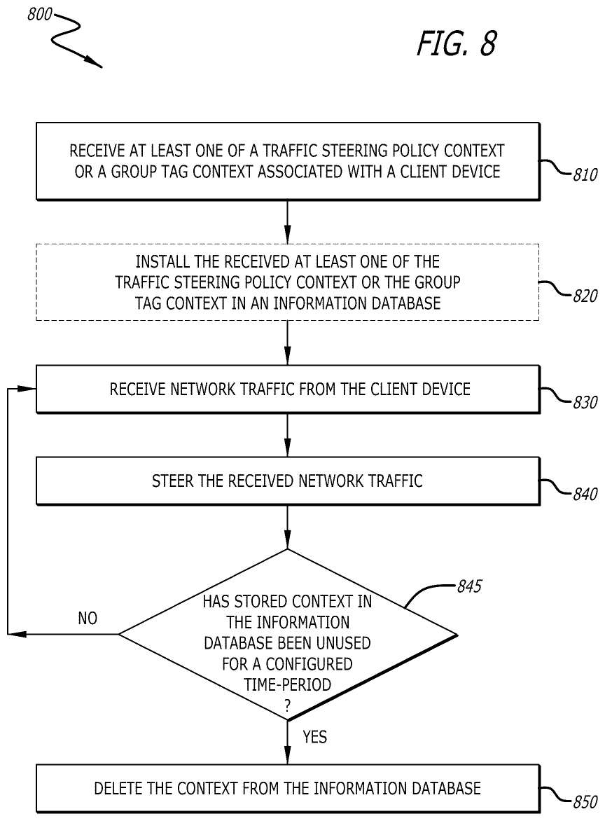

Referring to FIG. 8, a flowchart depicting a process 800 for edge-based roaming context management in accordance with various embodiments of the disclosure is shown. In many embodiments, the process 800 may be performed by a network node (e.g., an edge node, an edge node device, an egress node, or the like). The edge node may be equipped with a roaming management logic for facilitating edge-based roaming context management in a wireless network. In many embodiments, the process 800 may receive at least one of a traffic steering policy context or a group tag context associated with a client device (block 810). The client device may have roamed to the edge node from another edge node in the network. The traffic steering policy may define how network traffic from the client device should be handled, such as prioritizing specific types of data or directing the network traffic through preferred network paths. For example, the traffic steering policy context may include one or more configurations to steer network traffic of the client device. The group tag context may be utilized in categorizing the network traffic of the client device by mapping DIPs to predefined network groups such as DGTs. For example, the group tag context may include one or more DIP to DGT mappings associated with the client device. In further examples, the group tag context may include one or more DIP to DGT mappings associated with the client device that are different between the “roamed to” edge node and “previously coupled” edge node. In various embodiments, the reception of the at least one of the traffic steering policy context or the group tag context is independent of solicitation from the process 800. In yet various embodiments, the reception of the at least one of the traffic steering policy context or the group tag context to the subset of edge nodes is without solicitation from the process 800. In still various embodiments, the reception of the at least one of the traffic steering policy context or the group tag context is prior to an arrival of network traffic associated with the client device.

In additional embodiments, the process 800 may install the received at least one of the traffic steering policy context or the group tag context in an information database (block 820). The information database may correspond to a forward information base (FIB) or a routing information base (RIB). The information database may serve as a reference for making real-time decisions about network traffic handling associated with a plurality of client devices similar to the client device (e.g., having the same SGT, having the same DGT, or having the same user group). In many additional embodiments, the installation of the received at least one of the traffic steering policy context or the group tag context in the information database may be optional.

In a variety of embodiments, the process 800 may receive the network traffic from the client device (block 830). That is to say, once the process 800 detects the arrival of network traffic from the client device, the process 800 may proceed to receive and process the incoming network traffic. The processing of the network traffic may be based on the already received traffic steering policy context or the group tag context without having to wait for the edge node to request for the traffic steering policy context or the group tag context from a service control plane device or a policy server (e.g., ISE). For example, an EID to SGT mapping or the DIP to DGT mappings associated with the client device may be utilized to categorize the network traffic of the client device towards a designated route without any delay or packet loss.

In further additional embodiments, the process 800 may steer the received network traffic (block 840). With the relevant traffic steering policies or the group tag contexts stored, the process 800 may apply traffic steering policies or the group tag contexts to direct the network traffic of the client device. Steering the received network traffic may be based on the received at least one of the traffic steering policy context or the group tag context. The steering of the received network traffic may ensure that one or more packets of the network traffic of the client device may follow optimal paths, whether prioritizing low-latency routes, enforcing security protocols, or balancing network load. For example, corporate traffic may be steered through a VPN for security, while general web browsing may take a different path.

In several additional embodiments, the process 800 may determine whether stored context in the information database has been unused for a configured time-period (block 845). If the stored context is in active use after periodic intervals of time and the periodic intervals of time are less than the configured time-period, the process 800 may keep monitoring for the usage of the stored context in the information database against the configured time-period. However, if the stored context in the information database has been determined to be unused for the configured time-period, in a number of embodiments, the process 800 may delete the context information (e.g., the received at least one of the traffic steering policy context or the group tag context) (block 850). That is to say, to maintain efficiency and avoid unnecessary data retention, the process 800 may automatically remove unused traffic steering policies or group tag contexts after the configured time-period of inactivity. If the client device has not sent network traffic for a time interval that is greater than the configured time-period, the process 800 may assume that the stored at least one of the traffic steering policy context or the group tag context is no longer needed and may delete the context information from the information database. This helps free up storage, reduce processing overhead, and ensure that only relevant, actively used traffic steering policy context or group tag context remain in the information database of the edge node.

Although a specific embodiment for edge-based roaming context management suitable for carrying out the various steps, processes, methods, and operations described herein is discussed with respect to FIG. 8, any of a variety of systems and/or processes may be utilized in accordance with embodiments of the disclosure. For example, if the edge node does not have the SGT of the client device locally, or the SGT gets deleted after inactivity for the configured period of time, the process may utilize a Security Group Tag Exchange Protocol (SXP) to obtain the DIP-to-SGT mappings from other SXP-capable devices or directly from a policy server (e.g., the ISE) by transmitting one or more requests to the SXP-capable devices or the policy server. The elements depicted in FIG. 8 may also be interchangeable with other elements of FIGS. 1-7 and 9 as required to realize a particularly desired embodiment.

Referring to FIG. 9, a conceptual block diagram of a device 900 suitable for configuration with a roaming management logic in accordance with various embodiments of the disclosure is shown. The embodiment of the conceptual block diagram depicted in FIG. 9 can illustrate a network device such as policy server or a service control plane device, a server, a switch, a wireless LAN controller, a computer, a workstation, desktop computer, a laptop, a tablet, a network appliance, a e-reader, a smartphone, or other computing device, and can be utilized to execute any of the application and/or logic components presented herein. The embodiment of the conceptual block diagram depicted in FIG. 9 can also illustrate an AP, a switch, an edge node, or a router in accordance with various embodiments of the disclosure. The device 900 may, in many non-limiting examples, correspond to physical devices or virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems. In an example, the NIC 912 may correspond to a network interface controller configured to provide access to the network 940 comprising a plurality of edge nodes.

In further embodiments, the device 900 can be connected to a storage 918 that provides non-volatile storage for data accessible by the device 900. The storage 918 can, for instance, store an operating system 920 and programs 922 (e.g., applications). The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as programs 922 (e.g., an application) and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8 . In certain embodiments, the device 900 can also include computer-readable storage media having instructions stored thereupon for performing any of the other computer-implemented operations described herein.

In many further embodiments, the device 900 may include a roaming management logic 924. The roaming management logic 924 can be configured to perform one or more of the various steps, processes, operations, and/or other methods that are described above. Often, the roaming management logic 924 can be a set of instructions stored within a non-volatile memory that, when executed by the processor(s)904 can carry out these steps, etc. In some embodiments, the roaming management logic 924 may be a client application that resides on a network-connected device, such as, but not limited to, a server, switch, personal or mobile computing device in a single or distributed arrangement.

In various aspects, the device 900 can be a network device that may perform edge-based roaming context management using the roaming management logic 924. The roaming management logic 924 may be configured to maintain traffic steering policy information associated with a plurality of client devices that may include at least one traffic steering policy context of a client device of the plurality of client devices. The roaming management logic 924 may be configured to detect the client device roaming from a first edge node among a plurality of edge nodes in the network. The roaming management logic 924 may identify a subset of edge nodes among the plurality of edge nodes to which the client device may roam to. The roaming management logic 924 may transmit at least one of the traffic steering policy context or a group tag context associated with the client device to the identified subset of edge nodes among the plurality of edge nodes based on the detection of the client device roaming from the first edge node. The subset of edge nodes may include at least a second edge node to which the client device is roaming from the first edge node.

The roaming management logic 924 may be further configured to receive a list of one or more neighbor access points associated with an access point associated with the first edge node. The roaming management logic 924 may be configured to identify, from among the plurality of edge nodes, the subset of edge nodes associated with the one or more neighbor access points in the received list. The transmission of the at least one of the traffic steering policy context or the group tag context associated with the client device may be further based on the identification of the subset of edge nodes. The roaming management logic 924 may be further configured to receive a historical roaming pattern of the client device and predict a roaming pattern of the client device based on the historical roaming pattern. The roaming management logic 924 may be configured to identify, from among the plurality of edge nodes, the subset of edge nodes based on the roaming pattern of the client device. The transmission of the at least one of the traffic steering policy context or the group tag context associated with the client device may be unsolicited and may be further based on the identification of the subset of edge nodes.

The roaming management logic 924 may be further configured to receive one or more requests from the first edge node. The roaming management logic 924 may be configured to maintain a plurality of Destination Internet Protocol to Destination Group Tag mappings associated with the one or more requests. The plurality of DIP to DGT mappings may include the group tag context associated with the client device.

In additional aspects, the device 900 can be an edge node that has the roaming management logic 924. In such aspects, the roaming management logic 924 may be configured to receive, prior to an arrival of network traffic associated with a client device and without solicitation, at least one of a traffic steering policy context or a group tag context associated with the client device. The roaming management logic 924 may be further configured to receive the network traffic from the client device and steer the received network traffic based on the received at least one of the traffic steering policy context or the group tag context. The roaming management logic 924 may be further configured to install the received at least one of the traffic steering policy context or the group tag context in an information database, for example, the edge node data 932. The roaming management logic 924 may be further configured to delete the received at least one of the traffic steering policy context or the group tag context from the information database based on the received at least one of the traffic steering policy context or the group tag context being unused for a configured time-period.

In some embodiments, the storage 918 can include traffic steering policy data 928. The traffic steering policy data 928 may include rules and policies that dictate how network traffic may be managed and routed based on various factors such as QoS, application type, user identity, or network conditions. For example, the traffic steering policy data 928 may include rules such as application-based routing, where voice over IP (VoIP) traffic may be prioritized over general web browsing to ensure low latency and high call quality. The traffic steering policy data 928 may also include bandwidth allocation policies, such as limiting video streaming to a predetermined limit (e.g. 5 Mbps, 10 Mbps, or the like) per user during peak hours to prevent network congestion. The traffic steering policy data 928 may further include path selection policies to steer enterprise traffic through a secure VPN while allowing general web traffic to take a direct internet breakout for efficiency. Load balancing rules included in the traffic steering policy data 928 may be utilized to distribute traffic across multiple links based on real-time bandwidth availability, while geo-based steering policies can direct traffic to the nearest data center for improved performance. Additionally, security-driven steering include in the traffic steering policy data 928 can redirect suspicious traffic to an inspection gateway before allowing access to critical resources.

In various embodiments, the storage 918 can include group tag context data 930. The group tag context data 930 may refer to information that categorizes client devices, applications, or network destinations into logical groups based on shared characteristics, policies, or security requirements. The group tag context data 930 may include DIP-to-DGT mappings, which classify specific destinations into predefined categories for policy enforcement. For example, all cloud storage services can be assigned a common DGT to apply unified access controls. Source Group Tags (SGTs) included in the group tag context data 930 may be utilized to categorize client devices based on roles, such as assigning corporate employees to one SGT and guest users to another, ensuring different security policies apply. Further, the group tag context data 930 may include access control lists (ACLs) linked to group tags that may be utilized to define permissions for different groups, such as allowing internal employees to access corporate servers while blocking guest devices.

In a number of embodiments, the storage 918 can include edge node data 932. The edge node data 932 may include device metadata, such as IP addresses, MAC addresses, and hardware capabilities of access points, routers, and switches managing client device connections. The edge node data 932 may further include network topology data that may provide information about the relationships between edge nodes, detailing their connectivity to core routers, cloud gateways, and data centers. The edge node data 932 may further include traffic load and utilization statistics that may be utilized in dynamic resource allocation, such as detecting congestion on one access point and offloading traffic to a neighboring edge node. Client association history may be included in the edge node data 932 which may be utilized to track client devices that may frequently connect to specific edge nodes. The edge node data 932 may also include security posture data that may provide information on edge node compliance with security policies, such as whether encryption is enabled or intrusion detection is active. Further, edge node data 932 may include service capabilities that may describe the functions an edge node can perform, such as firewall enforcement, packet inspection, or SD-WAN routing, ensuring traffic is processed correctly based on network policies.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a ML model 926 (e.g., feature vectors), and or other pre-processing techniques. The ML model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. In an example, the ML model 926 may include the plurality of classifiers, each trained for a specific task such as edge-based roaming management of network traffic of a plurality of client devices in the network, that share common encoder(s).

The ML model(s) 926 can be configured to generate inferences to make predictions or draw conclusions from data. An inference can be considered the output of a process of applying a model to new data. This can occur by learning from at least the traffic steering policy data 928, the group tag context data 930, and the edge node data 932. These predictions are based on patterns and relationships discovered within the data. To generate an inference, the trained model can take input data and produce a classification result. The input data can be in various forms, such as images, audio, text, or numerical data, network packet data depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes. In several embodiments, the ML model(s) 926 may be configured to determine the group tag context data 930 based on the edge node data 932. Further, the ML model(s) 926 may be configured to identify the traffic steering policy data 928 for transmitting the traffic steering policy data 928 to one or more edge nodes to which a client device may roam to. For example, the ML model(s) 926 may examine historical roaming pattern of the client device to identify or predict roaming patterns or roaming trends of the client device. By learning from historical roaming pattern, the ML model(s) 926 can predict the current roaming pattern of the client device with a high probability of identify one or more edge nodes that the client device may roam to. In other words, once trained, the ML model(s) 926 may be further deployed on the device 900 (e.g., a service control plane device, a policy server, a WLC, or the like) for edge-based roaming management of network traffic of the client device roaming in the network.

Although a specific embodiment for a device suitable for configuration with the roaming management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or APs. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network comprising a plurality of edge nodes; and
a memory communicatively coupled to the processor, wherein the memory comprises a roaming management logic configured to:
detect a client device roaming from a first edge node among the plurality of edge nodes; and
transmit at least one of a traffic steering policy context or a group tag context associated with the client device to a subset of edge nodes among the plurality of edge nodes based on the detection of the client device roaming from the first edge node, wherein the subset of edge nodes comprises at least a second edge node to which the client device is roaming from the first edge node.

2. The network device of claim 1, wherein the group tag context comprises one or more Destination Internet Protocol to Destination Group Tag mappings associated with the client device.

3. The network device of claim 1, wherein the group tag context comprises one or more Destination Internet Protocol to Destination Group Tag mappings associated with the client device that are different between the first edge node and at least one edge node in the subset of edge nodes.

4. The network device of claim 1, wherein the traffic steering policy context comprises one or more configurations to steer network traffic of the client device.

5. The network device of claim 1, wherein the transmission of the at least one of the traffic steering policy context or the group tag context to the second edge node is prior to an arrival of network traffic associated with the client device at the second edge node.

6. The network device of claim 1, wherein the transmission of the at least one of the traffic steering policy context or the group tag context to the subset of edge nodes is independent of solicitation from the subset of edge nodes.

7. The network device of claim 6, wherein the transmission of the at least one of the traffic steering policy context or the group tag context to the subset of edge nodes is without solicitation from the subset of edge nodes.

8. The network device of claim 1, wherein prior to roaming, the client device is communicatively coupled to an access point (AP) associated with the first edge node, and wherein the roaming management logic is further configured to:
receive a list of one or more neighbor access points associated with the access point; and
identify, from among the plurality of edge nodes, the subset of edge nodes associated with the one or more neighbor access points in the received list, wherein the transmission of the at least one of the traffic steering policy context or the group tag context associated with the client device is further based on the identification of the subset of edge nodes.

9. The network device of claim 1, wherein the roaming management logic is further configured to:
receive a historical roaming pattern of the client device;
predict a roaming pattern of the client device based on the historical roaming pattern; and
identify, from among the plurality of edge nodes, the subset of edge nodes based on the roaming pattern of the client device, wherein the transmission of the at least one of the traffic steering policy context or the group tag context associated with the client device is further based on the identification of the subset of edge nodes.

10. The network device of claim 1, wherein the network device corresponds to a service control plane node in the network.

11. The network device of claim 10, wherein the roaming management logic is further configured to maintain traffic steering policy information associated with a plurality of client devices including the client device, and wherein the traffic steering policy information comprises the traffic steering policy context of the client device.

12. The network device of claim 10, wherein the roaming management logic is further configured to:
receive one or more requests from the first edge node; and
maintain a plurality of Destination Internet Protocol to Destination Group Tag mappings associated with the one or more requests, wherein the group tag context associated with the client device comprises one or more Destination Internet Protocol to Destination Group Tag mappings of the plurality of Destination Internet Protocol to Destination Group Tag mappings.

13. The network device of claim 1, wherein the roaming management logic is further configured to transmit the at least one of the traffic steering policy context or the group tag context as a part of client-context associated with the client device.

14. The network device of claim 13, wherein the roaming management logic is further configured to transmit the at least one of the traffic steering policy context or the group tag context using a vendor-specific Locator/ID Separation Protocol (LISP) Location-Class Attribute Format (LCAF) message format.

15. The network device of claim 1, wherein the subset of edge nodes comprises one or more network access devices (NAD) in the network.

16. An edge node device, comprising:
a processor;
a network interface controller configured to provide access to a network; and
a memory communicatively coupled to the processor, wherein the memory comprises a roaming management logic that is configured to:
receive, prior to an arrival of network traffic associated with a client device and without solicitation, at least one of a traffic steering policy context or a group tag context associated with the client device;
receive the network traffic from the client device; and
steer the received network traffic based on the received at least one of the traffic steering policy context or the group tag context.

17. The edge node device of claim 16, wherein the client device has roamed to the edge node device from another edge node device in the network.

18. The edge node device of claim 16, wherein the roaming management logic is further configured to install the received at least one of the traffic steering policy context or the group tag context in an information database.

19. The edge node device of claim 18, wherein the roaming management logic is further configured to delete the received at least one of the traffic steering policy context or the group tag context from the information database based on the received at least one of the traffic steering policy context or the group tag context being unused for a configured time-period.

20. A method, comprising:
detecting a client device roaming from a first edge node among a plurality of edge nodes; and
transmitting at least one of a traffic steering policy context or a group tag context associated with the client device to a subset of edge nodes among the plurality of edge nodes based on the detection of the client device roaming from the first edge node, wherein the subset of edge nodes comprises at least a second edge node to which the client device is roaming from the first edge node.
